(19) United States
(12) Patent Application Publication
(10) Pub. No.: US 2006/0264544 A1
(43) Pub. Date: Nov. 23, 2006

(54) Cloth-like fiber reinforced polypropylene compositions and method of making thereof

(76) Inventors: Arnold Lustiger, Edison, NJ (US); Jeffrey Valentage, Royal Oak, MI (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 11/395,493

(22) Filed: Mar. 31, 2006

Related U.S. Application Data
(63) Continuation-in-part of application No. 11/318,363, filed on Dec. 23, 2005.
(63) Continuation-in-part of application No. 11/301,533, filed on Dec. 13, 2005.
(60) Provisional application No. 60/681,609, filed on May 17, 2005.

(51) Int. Cl. C08K 5/00

(52) U.S. Cl. 524/284; 524/423; 524/425; 524/431; 524/432; 524/445; 524/449; 524/451

(57) ABSTRACT

The present invention is directed generally to cloth-like fiber reinforced polypropylene compositions, and the beneficial mechanical and aesthetic properties imparted by such compositions. The cloth-like fiber reinforced polypropylene compositions include at least 25 wt % polypropylene based polymer, from 5 to 60 wt % organic reinforcing fiber, from 0 to 60 wt % inorganic filler, and from 0.1 to 2.5 wt % colorant fiber. A method of making fiber reinforced polypropylene compositions and molding articles there from is also disclosed and includes the steps of twin screw extrusion compounding the composition to form a resin and injection molding the resin to form a cloth-like article. Articles molded from these fiber reinforced polypropylene compositions have a flexural modulus of at least 300,000 psi, exhibit ductility during instrumented impact testing, and exhibit a cloth-like appearance. The cloth-like fiber reinforced polypropylene compositions of the present invention are particularly suitable for making molded articles including, but not limited to household appliances, automotive parts, and boat hulls.

### CROSS-REFERENCE TO RELATED APPLICATION

This application is a Continuation-in-Part of U.S. patent application Ser. No. 11/318,363 filed Dec. 23, 2005, and is also a Continuation-in-Part of U.S. patent application Ser. No. 11/301,533 filed Dec. 13, 2005, and claims priority of U.S. Provisional Application 60/681,609 filed May 17, 2005.

### FIELD OF THE INVENTION

The present invention is directed generally to articles made from fiber reinforced polypropylene compositions having a flexural modulus of at least 300,000 psi and exhibiting ductility during instrumented impact testing. It more particularly, the present invention relates to cloth-like fiber reinforced polypropylene compositions of matter and processes for making such articles. Still more particularly, the present invention relates to polypropylene based fiber composites including a propylene based polymer, an organic reinforcing fiber, a colorant fiber, and an inorganic filler.

### BACKGROUND OF THE INVENTION

Polyolefins have limited use in engineering applications due to the tradeoff between toughness and stiffness. For example, polyethylene is widely regarded as being relatively tough, but low in stiffness. Polypropylene generally displays the opposite trend, i.e., is relatively stiff, but low in toughness.

Several well known polypropylene compositions have been introduced which address toughness. For example, it is known to increase the toughness of polypropylene by adding rubber particles, either in-reactor resulting in impact copolymers, or through post-reactor blending. However, while toughness is improved, the stiffness is considerably reduced using this approach.

Glass reinforced polypropylene compositions have been introduced to improve stiffness. However, the glass fibers have a tendency to break in typical injection molding equipment, resulting in reduced toughness and stiffness. In addition, glass reinforced products have a tendency to warp after injection molding

Another known method of improving physical properties of polyolefins is organic fiber reinforcement. For example, EP Patent Application 0397881, the entire disclosure of which is hereby incorporated herein by reference, discloses a composition produced by melt-mixing 100 parts by weight of a polypropylene resin and 10 to 100 parts by weight of polyester fibers having a fiber diameter of 1 to 10 deniers, a fiber length of 0.5 to 50 mm and a fiber strength of 5 to 13 g/d, and then molding the resulting mixture. Also, U.S. Pat. No. 3,639,424 to Gray, Jr. et al., the entire disclosure of which is hereby incorporated herein by reference, discloses a composition including a polymer, such as polypropylene, and uniformly dispersed therein at least about 10% by weight of the composition staple length fiber, the fiber being of man-made polymers, such as poly(ethylene terephthalate) or poly(1,4-cyclohexylenedimethylene terephthalate).

Fiber reinforced polypropylene compositions are also disclosed in PCT Publication WO02/053629, the entire disclosure of which is hereby incorporated herein by reference. More specifically, WO02/053629 discloses a polymeric compound, comprising a thermoplastic matrix having a high flow during melt processing and polymeric fibers having lengths of from 0.1 mm to 50 mm. The polymeric compound comprises between 0.5 wt % and 10 wt % of a lubricant.

Various modifications to organic fiber reinforced polypropylene compositions are also known. For example, polyolefins modified with maleic anhydride or acrylic acid have been used as the matrix component to improve the interface strength between the synthetic organic fiber and the polyolefin, which was thought to enhance the mechanical properties of the molded product made therefrom.

Other background references include PCT Publication WO90/05164; EP Patent Application 0669372; U.S. Pat. No. 6,395,342 to Kadowaki et al.; EP Patent Application 1075918; U.S. Pat. No. 5,145,891 to Yasukawa et al., U.S. Pat. No. 5,145,892 to Yasukawa et al.; and EP Patent 0232522, the entire disclosures of which are hereby incorporated herein by reference.

U.S. Pat. No. 3,304,282 to Cadus et al. discloses a process for the production of glass fiber reinforced high molecular weight thermoplastics in which the plastic resin is supplied to an extruder or continuous kneader, endless glass fibers are introduced into the melt and broken up therein, and the mixture is homogenized and discharged through a die. The glass fibers are supplied in the form of endless rovings to an injection or degassing port downstream of the feed hopper of the extruder.

U.S. Pat. No. 5,401,154 to Sargent discloses an apparatus for making a fiber reinforced thermoplastic material and forming parts therefrom. The apparatus includes an extruder having a first material inlet, a second material inlet positioned downstream of the first material inlet, and an outlet. A thermoplastic resin material is supplied at the first material inlet and a first fiber reinforcing material is supplied at the second material inlet of the compounding extruder, which discharges a molten random fiber reinforced thermoplastic material at the extruder outlet. The fiber reinforcing material may include a bundle of continuous fibers formed from a plurality of monofilament fibers. Fiber types disclosed include glass, carbon, graphite and Kevlar.

U.S. Pat. No. 5,595,696 to Schlarb et al. discloses a fiber composite plastic and a process for the preparation thereof and more particularly to a composite material comprising continuous fibers and a plastic matrix. The fiber types include glass, carbon and natural fibers, and can be fed to the extruder in the form of chopped or continuous fibers. The continuous fiber is fed to the extruder downstream of the resin feed hopper.

U.S. Pat. No. 6,395,342 to Kadowaki et al. discloses an impregnation process for preparing pellets of a synthetic organic fiber reinforced polyolefin. The process comprises the steps of heating a polyolefin at the temperature which is higher than the melting point thereof by 40 degree C. or more to lower than the melting point of a synthetic organic fiber to form a molten polyolefin; passing a reinforcing fiber comprising the synthetic organic fiber continuously through the molten polyolefin within six seconds to form a polyolefin impregnated fiber; and cutting the polyolefin impregnated fiber into the pellets. Organic fiber types include polyethylene terephthalate, polybutylene terephthalate, polyamide 6, and polyamide 66.

U.S. Pat. No. 6,419,864 to Scheuring et al. discloses a method of preparing filled, modified and fiber reinforced thermoplastics by mixing polymers, additives, fillers and fibers in a twin screw extruder. Continuous fiber rovings are fed to the twin screw extruder at a fiber feed zone located downstream of the feed hopper for the polymer resin. Fiber types disclosed include glass and carbon.

Consistently feeding PET fibers into a compounding extruder is an issue encountered during the production of PP-PET fiber composites. Gravimetric or vibrational feeders are used in the metering and conveying of polymers, fillers and additives into the extrusion compounding process. These feeders are designed to convey materials at a constant rate using a single or twin screw by measuring the weight loss in the hopper of the feeder. These feeders are effective in conveying pellets or powder, but are not effective in conveying cut fiber. Cut fiber tends to bridge and entangle in these feeders resulting in an inconsistent feed rate to the compounding process. More particularly, at certain times, fiber gets hung up in the feeder and little is conveyed, while at other times, an overabundance of fiber is conveyed to the compounding extruder.

Another issue encountered during the production of PP-PET fiber composites is adequately dispersing the PET fibers into the PP matrix while still maintaining the advantageous mechanical properties imparted by the incorporation of the PET fibers. More particularly, extrusion compounding screw configuration may impact the dispersion of PET fibers within the PP matrix, and extrusion compounding processing conditions may impact not only the mechanical properties of the matrix polymer, but also the mechanical properties of the PET fibers.

Interior automotive parts often require a unique combination of toughness, stiffness and aesthetics. Many of these parts are based on polypropylene copolymers with various additives to achieve this desired combination of properties. Polypropylene homopolymer is typically stiff, but too brittle for many of these applications. As result, various rubbers, including ethylene-propylene diene rubber, are incorporated to increase toughness, either in the polymerization reactor to synthesize a so-called impact copolymer, or through blending.

Many interior automotive parts also require a cloth-like appearance and feel. To create such a cloth-like look in polypropylene (PP) or thermoplastic olefin TPO) materials, various fiber based additives are added to a base polymer product. Typically the base material is a light gray color and the fiber based additives are a darker gray or blue color to create the cloth-like effect. However, the presence of these fibers causes a significant decrease in impact properties. To counter balance the loss of impact resistance, typically plastomers or ethylene-propylene-diene rubber (EPDM) are added. However these modifiers also lower the stiffness (flexural modulus) of the product, and substantially increase the raw material cost.

A need exists for an improved polypropylene based composite material that yields a combination of improved aesthetics, impact resistance/toughness, and stiffness for use in molded articles at favorable raw material and manufacturing costs. In addition, the polypropylene based composite material when formed into molded articles will ideally not splinter after subjected to break through drop weight impact testing, and will also have a cloth-like appearance and feel.

### SUMMARY OF THE INVENTION

It has surprisingly been found that substantially lubricant-free cloth-like fiber reinforced polypropylene compositions can be made which simultaneously have a flexural modulus of at least 300,000 psi and exhibit ductility during instrumented impact testing. More particularly, the cloth-like fiber reinforced polypropylene compositions surprisingly exhibit no decrease in impact properties upon the incorporation of colorant fiber needed to attain a cloth-like look. Still more particularly is the surprising ability to make such compositions using a wide range of polypropylenes as the matrix material, including some polypropylenes that without fiber are very brittle. The compositions of the present invention are particularly suitable for making articles including, but not limited to household appliances, automotive parts, and boat hulls.

In one embodiment, the present invention provides an advantageous polypropylene resin composition comprising, based on the total weight of the composition, (a) at least 30 wt % polypropylene based polymer; (b) from 10 to 60 wt % organic reinforcing fiber; (c) from 0 to 40 wt % inorganic filler; and (d) from 0.1 to 2.5 wt % colorant fiber; and wherein an article molded from the composition has a flexural modulus of at least 300,000 psi, exhibits ductility during instrumented impact testing, and exhibits a cloth-like appearance.

In another embodiment, the present invention provides an advantageous polypropylene resin composition comprising, based on the total weight of the composition, (a) at least 25 wt polypropylene based polymer with a melt flow rate of from about 20 to about 1500 g/10 minutes; (b) from 5 to 40 wt %, organic reinforcing fiber; (c) from 10 to 60 wt % inorganic filler; and (d) from 0.1 to 2.5 wt % colorant fiber; and wherein an article molded from the composition has a flexural modulus of at least about 300,000 psi, exhibits ductility during instrumented impact testing, and exhibits a cloth-like appearance.

In yet another embodiment, the present invention provides an advantageous polypropylene resin composition comprising, based on the total weight of the composition, (a) at least 30 wt % polypropylene based polymer; (b) from 5 to 40 wt % organic reinforcing fiber; (c) from 10 to 60 wt % inorganic filler; (d) from 0.01 to 0.1 wt % lubricant; and (e) from 0.1 to 1.0 wt % colorant fiber; and wherein an article molded from the composition has a flexural modulus of at least about 300,000 psi, exhibits ductility during instrumented impact testing, and exhibits a cloth-like appearance.

In yet another embodiment of the present disclosure provides an advantageous polypropylene resin composition comprising, based on the total weight of the composition, (a) at least 25 wt % polypropylene based polymer, wherein said polypropylene based polymer has a melt flow rate of at least 80 g/10 minutes; (b) from 5 to 15 wt % organic reinforcing fiber; (c) from 50 to 60 wt % talc or wollastonite; and (d) from 0.1 to 1.0 wt % colorant fiber; wherein an article molded from the composition has a flexural modulus of at least about 750,000 psi, exhibits ductility during instrumented impact testing, and exhibits a cloth-like appearance.

In still yet another embodiment of the present disclosure provides an advantageous polypropylene resin composition comprising, based on the total weight of the composition, (a) at least 40 wt % polypropylene based polymer, wherein said polypropylene based polymer has a melt flow rate of at least 100 g/10 minutes; (b) from 10 to 30 wt % organic reinforcing fiber; (c) from 10 to 30 wt % talc or wollastonite; and (d) from 0.1 to 1.0 wt % colorant fiber; and wherein an article molded from the composition has a flexural modulus of at least about 325,000 psi, exhibits ductility during instrumented impact testing, and exhibits a cloth-like appearance.

In still yet another embodiment of the present disclosure provides an advantageous method of making an article from a polypropylene resin composition comprising, based on the total weight of the composition, (a) at least 30 wt % polypropylene based polymer; (b) from 10 to 60 wt % organic reinforcing fiber; (c) from 0 to 40 wt % inorganic filler; and (d) from 0.1 to 2.5 wt % colorant fiber; wherein the article molded from said composition has a flexural modulus of at least 300,000 psi, exhibits ductility during instrumented impact testing, and exhibits a cloth-like appearance; and wherein the method comprises the steps of: (a) twin screw extrusion compounding the composition to form a resin; and (b) injection molding the resin to form an article.

In still yet another embodiment of the present disclosure provides an advantageous method of making an article from a polypropylene resin composition comprising, based on the total weight of the composition, (a) at least 25 wt % polypropylene based polymer with a melt flow rate of from about 20 to about 1500 g/10 minutes; (b) from 5 to 40 wt % organic reinforcing fiber; (c) from 10 to 60 wt % inorganic filler; and (d) from 0.1 to 2.5 wt % colorant fiber; wherein an article molded from the composition has a flexural modulus of at least about 300,000 psi, exhibits ductility during instrumented impact testing, and exhibits a cloth-like appearance; and wherein the method comprises the steps of: (a) feeding into a twin screw extruder hopper the polypropylene based polymer; (b) continuously feeding by unwinding from one or more spools into the twin screw extruder hopper the organic reinforcing fiber; (c) feeding into the twin screw extruder the inorganic filler and the colorant fiber; (d) extruding the polypropylene based resin, the organic reinforcing fiber, the inorganic filler, and the colorant fiber through the twin screw extruder to form a fiber reinforced polypropylene composite melt; (e) cooling the fiber reinforced polypropylene composite melt to form a solid polypropylene composition; and (f) pelletizing the solid polypropylene composition to form a fiber reinforced polypropylene resin composition.

Numerous advantages result from the advantageous cloth-like polypropylene fiber composites, method of making disclosed herein and the uses/applications therefore.

For example, in exemplary embodiments of the present disclosure, the disclosed cloth-like polypropylene fiber composites exhibit improved instrumented impact resistance.

In a further exemplary embodiment of the present disclosure, the disclosed cloth-like polypropylene fiber composites exhibit improved flexural modulus.

In a further exemplary embodiment of the present disclosure, the disclosed cloth-like polypropylene fiber composites do not splinter during instrumented impact testing.

In yet a further exemplary embodiment of the present disclosure, the disclosed cloth-like polypropylene fiber composites exhibit fiber pull out during instrumented impact testing without the need for lubricant additives.

In yet a further exemplary embodiment of the present disclosure, the disclosed cloth-like polypropylene fiber composites exhibit a higher heat distortion temperature compared to rubber toughened polypropylene.

In yet a further exemplary embodiment of the present disclosure, the disclosed cloth-like polypropylene fiber composites exhibit a lower flow and cross flow coefficient of linear thermal expansion compared to rubber toughened polypropylene.

In yet another exemplary embodiment of the present disclosure, the disclosed method of making fiber reinforced polypropylene composite pellets exhibits the ability to continuously and accurately feed organic reinforcing fiber into a twin screw compounding extruder.

In another exemplary embodiment of the present disclosure, the disclosed method of making fiber reinforced polypropylene composite pellets exhibits uniform dispersion of the organic reinforcing fiber and colorant fiber in the pellets.

In another exemplary embodiment of the present disclosure, the disclosed method of making fiber reinforced polypropylene composite pellets exhibits the beneficial mechanical properties imparted by the organic reinforcing fiber in the pellets even after the addition of colorant fiber in the pellets.

In yet a further exemplary embodiment of the present disclosure, the disclosed cloth-like polypropylene fiber composites exhibit a cloth-like look.

In yet a further exemplary embodiment of the present disclosure, the disclosed cloth-like polypropylene fiber composites exhibit a cloth-like feel.

In yet a further exemplary embodiment of the present disclosure, the disclosed cloth-like polypropylene fiber composites retain their impact resistance, ductile failure mode and stiffness after the incorporation of colorant fiber.

In yet a further exemplary embodiment of the present disclosure, the disclosed cloth-like polypropylene fiber composites are suitable for use in interior automotive parts.

These and other advantages, features and attributes of the disclosed cloth-like polypropylene fiber composites, and method of making of the present disclosure and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 depicts an exemplary schematic of the method of making cloth-like fiber reinforced polypropylene composites of the instant invention.

FIG. 2 depicts an exemplary schematic of a twin screw extruder with a downstream feed port for making cloth-like fiber reinforced polypropylene composites of the instant invention.

FIG. 3 depicts an exemplary schematic of a twin screw extruder screw configuration for making cloth-like fiber reinforced polypropylene composites of the instant invention.

### DETAILED DESCRIPTION OF THE INVENTION

The present invention relates to improved fiber reinforced polypropylene compositions and method of making therein for use in molding applications. The fiber reinforced polypropylene compositions of the present invention are distinguishable over the prior art in comprising a combination of a polypropylene based matrix with organic reinforcing fiber and inorganic filler, which in combination advantageously yield articles molded from the compositions with a flexural modulus of at least 300,000 psi and ductility during instrumented impact testing (15 mph, −29° C., 25 lbs). The fiber reinforced polypropylene compositions of the present invention are also distinguishable over the prior art in comprising a polypropylene based matrix polymer with an advantageous high melt flow rate without sacrificing impact resistance. In addition, fiber reinforced polypropylene compositions of the present invention do not splinter during instrumented impact testing.

The present invention also relates to cloth-like fiber reinforced polypropylene compositions, which are distinguishable over the prior art in providing a combination of outstanding stiffness, impact resistance, and splinter resistance upon impact failure. Unlike the prior art cloth-like compositions, the cloth-like fiber reinforced polypropylene compositions of the present invention retain their impact properties upon the addition of additives required for imparting a cloth-like look.

The cloth-like fiber reinforced polypropylene compositions of the present invention simultaneously have desirable stiffness, as measured by having a flexural modulus of at least 300,000 psi, and toughness, as measured by exhibiting ductility during instrumented impact testing. In a particular embodiment, the compositions have a flexural modulus of at least 350,000 psi, or at least 370,000 psi, or at least 390,000 psi, or at least 400,000 psi, or at least 450,000 psi. Still more particularly, the compositions have a flexural modulus of at least 600,000 psi, or at least 800,000 psi. It is also believed that having a weak interface between the polypropylene matrix and the fiber contributes to fiber pullout; and, therefore, may enhance toughness. Thus, there is no need to add modified polypropylenes to enhance bonding between the organic reinforcing fiber and the polypropylene matrix, although the use of modified polypropylene may be advantageous to enhance the bonding between a filler such as talc or wollastonite and the matrix. In addition, in one embodiment, there is no need to add lubricant to weaken the interface between the polypropylene and the organic reinforcing fiber to further enhance fiber pullout. Some embodiments also display no splintering during instrumented dart impact testing, which yield a further advantage of not subjecting a person in close proximity to the impact to potentially harmful splintered fragments.

Compositions of the present invention generally include at least 30 wt %, based on the total weight of the composition, of polypropylene as the matrix resin. In a particular embodiment, the polypropylene is present in an amount of at least 30 wt %, or at least 35 wt %, or at least 40 wt %, or at least 45 wt %, or at least 50 wt %, or in an amount within the range having a lower limit of 30 wt %, or 35 wt %, or 40 wt %, or 45 wt %, or 50 wt %, and an upper limit of 75 wt %, or 80 wt %, based on the total weight of the composition. In another embodiment, the polypropylene is present in an amount of at least 25 wt %.

The polypropylene used as the matrix resin is not particularly restricted and is generally selected from the group consisting of propylene homopolymers, propylene-ethylene random copolymers, propylene-α-olefin random copolymers, propylene block copolymers, propylene impact copolymers, and combinations thereof. In a particular embodiment, the polypropylene is a propylene homopolymer. In another particular embodiment, the polypropylene is a propylene impact copolymer comprising from 78 to 95 wt % homopolypropylene and from 5 to 22 wt % ethylene-propylene rubber, based on the total weight of the impact copolymer. In a particular aspect of this embodiment, the propylene impact copolymer comprises from 90 to 95 wt % homopolypropylene and from 5 to 10 wt % ethylene-propylene rubber, based on the total weight of the impact copolymer.

The polypropylene of the matrix resin may have a melt flow rate of from about 20 to about 1500 g/10 min. In a particular embodiment, the melt flow rate of the polypropylene matrix resin is greater 100 g/10 min, and still more particularly greater than or equal to 400 g/10 min. In yet another embodiment, the melt flow rate of the polypropylene matrix resin is about 1500 g/10 min. The higher melt flow rate permits for improvements in processability, throughput rates, and higher loading levels of organic reinforcing fiber and inorganic filler without negatively impacting flexural modulus and impact resistance.

In a particular embodiment, the matrix polypropylene contains less than 0.1 wt % of a modifier, based on the total weight of the polypropylene. Typical modifiers include, for example, unsaturated carboxylic acids, such as acrylic acid, methacrylic acid, maleic acid, itaconic acid, fumaric acid or esters thereof, maleic anhydride, itaconic anhydride, and derivates thereof. In another particular embodiment, the matrix polypropylene does not contain a modifier. In still yet another particular embodiment, the polypropylene based polymer further includes from about 0.1 wt % to less than about 10 wt % of a polypropylene based polymer modified with a grafting agent. The grafting agent includes, but is not limited to, acrylic acid, methacrylic acid, maleic acid, itaconic acid, fumaric acid or esters thereof, maleic anhydride, itaconic anhydride, and combinations thereof.

The polypropylene may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment. The amount of additive, if present, in the polypropylene matrix is generally from 0.5 wt %, or 2.5wt %, to 7.5 wt %, or 10 wt %, based on the total weight of the matrix. Diffusion of additive(s) during processing may cause a portion of the additive(s) to be present in the organic reinforcing fiber.

The invention is not limited by any particular polymerization method for producing the matrix polypropylene, and the polymerization processes described herein are not limited by any particular type of reaction vessel. For example, the matrix polypropylene can be produced using any of the well known processes of solution polymerization, slurry polymerization, bulk polymerization, gas phase polymerization, and combinations thereof. Furthermore, the invention is not limited to any particular catalyst for making the polypropylene, and may, for example, include Ziegler-Natta or metallocene catalysts.

Compositions of the present invention generally include at least 10 wt %, based on the total weight of the composition, of an organic reinforcing fiber. In a particular embodiment, the fiber is present in an amount of at least 10 wt %, or at least 15 wt %, or at least 20 wt %, or in an amount within the range having a lower limit of 10 wt %, or 15 wt %, or 20 wt %, and an upper limit of 50 wt %, or 55 wt %, or 60 wt %, or 70 wt %, based on the total weight of the composition. In another embodiment, the organic reinforcing fiber is present in an amount of at least 5 wt % and up to 40 wt %.

The polymer used as the reinforcing fiber is not particularly restricted and is generally selected from the group consisting of polyalkylene terephthalates, polyalkylene naphthalates, polyamides, polyolefins, polyacrylonitrile, and combinations thereof. In a particular embodiment, the fiber comprises a polymer selected from the group consisting of polyethylene terephthalate (PET), polybutylene terephthalate, polyamide and acrylic. In another particular embodiment, the organic reinforcing fiber comprises PET.

In one embodiment, the organic reinforcing fiber is a single component fiber. In another embodiment, the organic reinforcing fiber is a multicomponent fiber wherein the fiber is formed from a process wherein at least two polymers are extruded from separate extruders and meltblown or spun together to form one fiber. In a particular aspect of this embodiment, the polymers used in the multicomponent reinforcing fiber are substantially the same. In another particular aspect of this embodiment, the polymers used in the multicomponent reinforcing fiber are different from each other. The configuration of the multicomponent reinforcing fiber can be, for example, a sheath/core arrangement, a side-by-side arrangement, a pie arrangement, an islands-in-the-sea arrangement, or a variation thereof. The reinforcing fiber may also be drawn to enhance mechanical properties via orientation, and subsequently annealed at elevated temperatures, but below the crystalline melting point to reduce shrinkage and improve dimensional stability at elevated temperature.

The length and diameter of the reinforcing fibers of the present invention are not particularly restricted. In a particular embodiment, the fibers have a length of ¼ inch, or a length within the range having a lower limit of ⅛ inch, or ⅙ inch, and an upper limit of ⅓ inch, or ½ inch. In another particular embodiment, the diameter of the reinforcing fibers is within the range having a lower limit of 10 μm and an upper limit of 100 μm.

The reinforcing fiber may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment.

The reinforcing fiber used to make the compositions of the present invention is not limited by any particular fiber form. For example, the fiber can be in the form of continuous filament yarn, partially oriented yarn, or staple fiber. In another embodiment, the fiber may be a continuous multifilament fiber or a continuous monofilament fiber.

In another exemplary embodiment of the present invention, the fiber reinforced polypropylene composition may be made cloth-like in terms of appearance, feel, or a combination thereof. Cloth-like appearance or look is defined as having a uniform short fiber type of surface appearance. Cloth-like feel is defined as having a textured surface or fabric type feel. The incorporation of the colorant fiber into the fiber reinforced polypropylene composition results in a cloth-like appearance. When the fiber reinforced polypropylene composition is processed through a mold with a textured surface, a cloth-like feel is also imparted to the surface of the resulting molded part.

Cloth-like fiber reinforced polypropylene compositions of the present invention generally include from about 0.1 to about 2.5 wt %, based on the total weight of the composition, of a colorant fiber. Still more preferably, the colorant fiber is present from about 0.5 to about 1.5 wt %, based on the total weight of the composition. Even still more preferably, the colorant fiber is present at less than about 1.0 wt %, based on the total weight of the composition.

The colorant fiber type is not particularly restricted and is generally selected from the group consisting of cellulosic fiber, acrylic fiber, nylon fiber or polyester type fiber. Polyester type fibers include, but are not limited to, polyethylene terephlalate, polybutylene terephalate, and polyethylene naphthalate. Polyamide type fibers include, but are not limited to, nylon 6, nylon 6,6, nylon 4,6 and nylon 6,12. In a particular embodiment, the colorant fiber is cellulosic fiber, also commonly referred to as rayon. In another particular embodiment, the colorant fiber is a nylon type fiber.

The colorant fiber used to make the compositions of the present invention is not limited by any particular fiber form prior to being chopped for incorporation into the fiber reinforced polypropylene composition. For example, the colorant fiber can be in the form of continuous filament yarn, partially oriented yarn, or staple fiber. In another embodiment, the colorant fiber may be a continuous multifilament fiber or a continuous monofilament fiber.

The length and diameter of the colorant fiber may be varied to alter the cloth-like appearance in the molded article. The length and diameter of the colorant fiber of the present invention is not particularly restricted. In a particular embodiment, the fibers have a length of less than about ¼ inch, or preferably a length of between about 1/32 to about ⅛ inch. In another particular embodiment, the diameter of the colorant fibers is within the range having a lower limit of about 10 μm and an upper limit of about 100 μm.

The colorant fiber is colored with a coloring agent, which comprises either inorganic pigments, organic dyes or a combination thereof. U.S. Pat. Nos. 5,894,048; 4,894,264; 4,536,184; 5,683,805; 5,328,743; and 4,681,803 disclose the use of coloring agents, the disclosures of which are incorporated herein by reference in their entirety. Exemplary pigments and dyes incorporated into the colorant fiber include, but are not limited to, phthalocyanine, azo, condensed azo, azo lake, anthraquinone, perylene/perinone, indigo/thioindigo, isoindolinone, azomethineazo, dioxazine, quinacridone, aniline black, triphenylmethane, carbon black, titanium oxide, iron oxide, iron hydroxide, chrome oxide, spinel-form calcination type, chromic acid, talc, chrome vermilion, iron blue, aluminum powder and bronze powder pigments. These pigments may be provided in any form or may be subjected in advance to various dispersion treatments in a manner known per se in the art. Depending on the material to be colored, the coloring agent can be added with one or more of various additives such as organic solvents, resins, flame retardants, antioxidants, ultraviolet absorbers, plasticizers and surfactants.

The base fiber reinforced polypropylene composite material that the colorant fiber is incorporated into may also be colored using the inorganic pigments, organic dyes or combinations thereof. Exemplary pigments and dyes for the base fiber reinforced polypropylene composite material may be of the same types as indicated in the preceding paragraph for the colorant fiber. Typically the base fiber reinforced polypropylene composite material is made of a different color or a different shade of color than the colorant fiber, such as to create a cloth-like appearance upon uniformly dispersing the short colorant fibers in the colored base fiber reinforced polypropylene composite material. In one particular exemplary embodiment, the base fiber reinforced polypropylene composite material is light grey in color and the colorant fiber is dark grey or blue in color to create a cloth-like look from the addition of the short colorant fiber uniformly dispersed through the base fiber reinforced polypropylene composite material.

The colorant fiber in the form of chopped fiber may be incorporated directly into the base fiber reinforced polypropylene composite material via the twin screw extrusion compounding process, or may be incorporated as part of a masterbatch resin to further facilitate the dispersion of the colorant fiber within the fiber reinforced polypropylene composite base material. When the colorant fiber is incorporated as part of a masterbatch resins, exemplary carrier resins include, but are not limited to, polypropylene homopolymer, ethylene-propylene copolymer, ethylene-propylene-butene-1 terpolymer, propylene-butene-1 copolymer, low density polyethylene, high density polyethylene, and linear low density polyethylene. In one exemplary embodiment, the colorant fiber is incorporated into the carrier resin at less than about 25 wt %. The colorant fiber masterbatch is then incorporated into the fiber reinforced polypropylene composite base material at a loading of from about 1 wt % to about 10 wt %, and preferably from about 2 to about 6 wt %. In a particularly preferred embodiment, the colorant fiber masterbatch is added at about 4 wt % based on the total weight of the composition. In another exemplary embodiment, a masterbatch of either black rayon or black nylon type fibers in linear low density polyethylene carrier resin is incorporated at a loading of about 4 wt % in the fiber reinforced polypropylene composite base material.

The colorant fiber or colorant fiber masterbatch may be fed to the twin screw extrusion compounding process with a gravimetric feeder at either the feed hopper or at a downstream feed port in the barrel of the twin screw extruder. Kneading and mixing elements are incorporated into the twin screw extruder screw design downstream of the colorant fiber or colorant fiber masterbatch injection point, such as to uniformly disperse the colorant fiber within the cloth-like fiber reinforced polypropylene composite material.

Compositions of the present invention optionally include inorganic filler in an amount of at least 1 wt %, or at least 5 wt %, or at least 10 wt %, or in an amount within the range having a lower limit of 0 wt %, or 1 wt %, or 5 wt %, or 10 wt %, or 15 wt %, and an upper limit of 25 wt %, or 30 wt %, or 35 wt %, or 40 wt %, based on the total weight of the composition. In yet another embodiment, the inorganic filler may be included in the polypropylene fiber composite in the range of from 10 wt % to about 60 wt %. In a particular embodiment, the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof. The talc may have a size of from about 1 to about 100 microns. In one particular embodiment, at a high talc loading of up to about 60 wt %, the polypropylene fiber composite exhibited a flexural modulus of at least about 750,000 psi and no splintering during instrumented impact testing (15 mph, −29° C., 25 lbs). In another particular embodiment, at a low talc loading of as low as 10 wt %, the polypropylene fiber composite exhibited a flexural modulus of at least about 325,000 psi and no splintering during instrumented impact testing (15 mph, −29° C., 25 lbs). In addition, wollastonite loadings of from 10 wt % to 60 wt % in the polypropylene fiber composite yielded an outstanding combination of impact resistance and stiffness.

In another particular embodiment, a cloth-like fiber reinforced polypropylene composition including a polypropylene based resin with a melt flow rate of 80 to 1500, 10 to 15 wt % of polyester fiber, and 50 to 60 wt % of inorganic filler displayed a flexural modulus of 850,000 to 1,200,000 psi and did not shatter during instrumented impact testing at −29 degrees centigrade, tested at 25 pounds and 15 miles per hour. The inorganic filler includes, but is not limited to, talc and wollastonite. This combination of stiffness and toughness is difficult to achieve in a polymeric based material. In addition, the fiber reinforced polypropylene composition has a heat distortion temperature at 66 psi of 140 degrees centigrade, and a flow and cross flow coefficient of linear thermal expansion of 2.2×10⁻⁵ and 3.3×10⁻⁵ per degree centigrade respectively. In comparison, rubber toughened polypropylene has a heat distortion temperature of 94.6 degrees centigrade, and a flow and cross flow thermal expansion coefficient of 10×10⁻⁵ and 18.6×10⁻⁵ per degree centigrade respectively.

The cloth-like fiber reinforced polypropylene compositions of the present invention yield an advantageous combination of toughness, stiffness, and aesthetics. In particular, instrumented impact of molded articles is not negatively affected by the incorporation of the colorant fiber. In addition, the failure mode during instrumented impact testing is ductile (non-splintering) as opposed to brittle (splintering).

Articles made from the compositions described herein include, but are not limited to automotive parts, household appliances, and boat hulls. Cloth-like articles are particularly suitable for interior automotive parts because of the unique combination of toughness, stiffness and aesthetics. More particularly, the non-splintering nature of the failure mode during instrumented impact testing, and the cloth-like look make the cloth-like reinforced polypropylene composites of the present invention particularly suited for interior automotive parts, even more particularly suited for interior trim cover panels. Exemplary, but not limiting, interior trim cover panels include steering wheel covers, head liner panels, dashboard panels, interior door trim panels, pillar trim cover panels, and under-dashboard panels. Pillar trim cover panels include a front pillar trim cover panel, a center pillar trim cover panel, and a quarter pillar trim cover panel.

Articles of the present invention are made by forming the cloth-like fiber-reinforced polypropylene composition into a resin and then injection molding the resin composition to form the article. To achieve a cloth-like surface feel in the article, the mold surface may also have a textured surface. The invention is not limited by any particular method for forming the compositions. For example, the compositions can be formed by contacting polypropylene, organic reinforcing fiber, colorant fiber, and optional inorganic filler in any of the well known processes of pultrusion or extrusion compounding. In a particular embodiment, the compositions are formed in an extrusion compounding process. In a particular aspect of this embodiment, the organic reinforcing fibers are cut prior to being placed in the extruder hopper. In another particular aspect of this embodiment, the organic reinforcing fibers are fed directly from one or more spools into the extruder hopper.

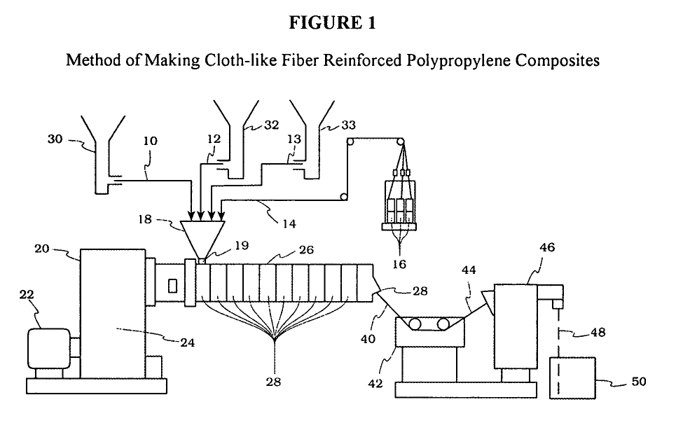

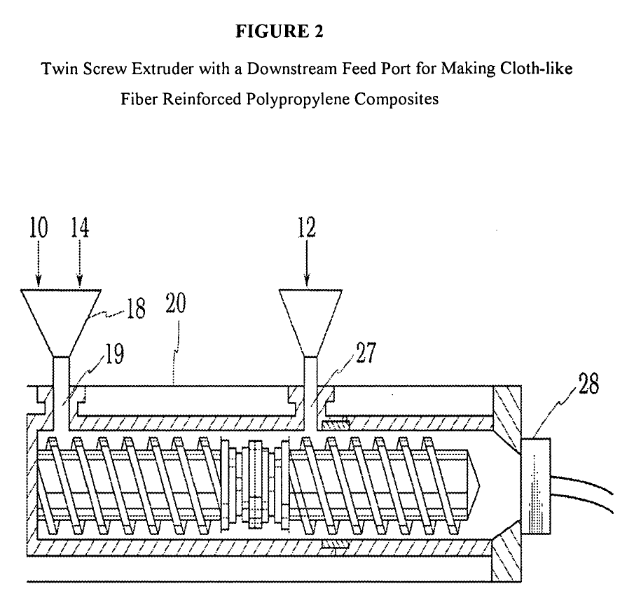

FIG. 1 depicts an exemplary schematic of the process for making cloth-like fiber reinforced polypropylene composites of the instant invention. Polypropylene based resin 10, inorganic filler 12, colorant fiber 13, and organic reinforcing fiber 14 continuously unwound from one or more spools 16 are fed into the extruder hopper 18 of a twin screw compounding extruder 20. Colorant fiber 13 is preferably in the form of a masterbatch resin. The extruder hopper 18 is positioned above the feed throat 19 of the twin screw compounding extruder 20. The extruder hopper 18 may alternatively be provided with an auger (not shown) for mixing the polypropylene based resin 10 and the inorganic filler 12 prior to entering the feed throat 19 of the twin screw compounding extruder 20. In an alternative embodiment, as depicted in FIG. 2, the inorganic filler 12 and/or the colorant fiber 13 may be fed to the twin screw compounding extruder 20 at a downstream feed port 27 in the extruder barrel 26 positioned downstream of the extruder hopper 18 while the polypropylene based resin 10 and the organic reinforcing fiber 14 are still metered into the extruder hopper 18.

The polypropylene based resin 10 is metered to the extruder hopper 18 via a feed system 30 for accurately controlling the feed rate. Similarly, the inorganic filler 12 and colorant fiber 13 are metered to the extruder hopper 18 via feed systems 32, 33 for accurately controlling the feed rate. The feed systems 30, 32, 33 may be, but are not limited to, gravimetric feed system or volumetric feed systems. Gravimetric feed systems are particularly preferred for accurately controlling the weight percentage of polypropylene based resin 10, inorganic filler 12, and colorant fiber 13 being fed to the extruder hopper 18. The feed rate of organic reinforcing fiber 14 to the extruder hopper 18 is controlled by a combination of the extruder screw speed, number of fiber filaments and the thickness of each filament in a given fiber spool, and the number of fiber spools 16 being unwound simultaneously to the extruder hopper 18. The higher the extruder screw speed measured in revolutions per minute (rpms), the greater will be the rate at which organic reinforcing fiber 14 is fed to the twin screw compounding screw 20. The rate at which organic reinforcing fiber 14 is fed to the extruder hopper also increases with the greater the number of filaments within the organic reinforcing fiber 14 being unwound from a single fiber spool 16, the greater filament thickness, the greater the number fiber spools 16 being unwound simultaneously, and the rotations per minute of the extruder.

The twin screw compounding extruder 20 includes a drive motor 22, a gear box 24, an extruder barrel 26 for holding two screws (not shown), and a strand die 28. The extruder barrel 26 is segmented into a number of heated temperature controlled zones 28. As depicted in FIG. 1, the extruder barrel 26 includes a total of ten temperature control zones 28. The two screws within the extruder barrel 26 of the twin screw compounding extruder 20 may be intermeshing or non-intermeshing, and may rotate in the same direction (co-rotating) or rotate in opposite directions (counter-rotating). From a processing perspective, the melt temperature must be maintained above that of the polypropylene based resin 10, and far below the melting temperature of the organic reinforcing fiber 14, such that the mechanical properties imparted by the organic fiber will be maintained when mixed into the polypropylene based resin 10. In one exemplary embodiment, the barrel temperature of the extruder zones did not exceed 154° C. when extruding PP homopolymer and PET fiber, which yielded a melt temperature above the melting point of the PP homopolymer, but far below the melting point of the PET fiber. In another exemplary embodiment, the barrel temperatures of the extruder zones are set at 185° C. or lower.

An exemplary schematic of a twin screw compounding extruder 20 screw configuration for making fiber reinforced polypropylene composites is depicted in FIG. 2. The feed throat 19 allows for the introduction of polypropylene based resin, organic reinforcing fiber, colorant fiber, and inorganic filler into a feed zone of the twin screw compounding extruder 20. The inorganic filler and colorant fiber may be optionally fed to the extruder 20 at the downstream feed port 27. The twin screws 30 include an arrangement of interconnected screw sections, including conveying elements 32 and kneading elements 34. The kneading elements 34 function to melt the polypropylene based resin, cut the organic reinforcing fiber lengthwise, and mix the polypropylene based melt, chopped organic reinforcing fiber, colorant fiber and inorganic filler to form a uniform blend. More particularly, the kneading elements function to break up the organic reinforcing fiber into about ⅛ inch to about 1 inch fiber lengths. A series of interconnected kneading elements 34 is also referred to as a kneading block. U.S. Pat. No. 4,824,256 to Haring, et al., herein incorporated by reference in its entirety, discloses co-rotating twin screw extruders with kneading elements. The first section of kneading elements 34 located downstream from the feed throat is also referred to as the melting zone of the twin screw compounding extruder 20. The conveying elements 32 function to convey the solid components, melt the polypropylene based resin, and convey the melt mixture of polypropylene based polymer, inorganic filler, colorant fiber and organic reinforcing fiber downstream toward the strand die 28 (see FIG. 1) at a positive pressure.

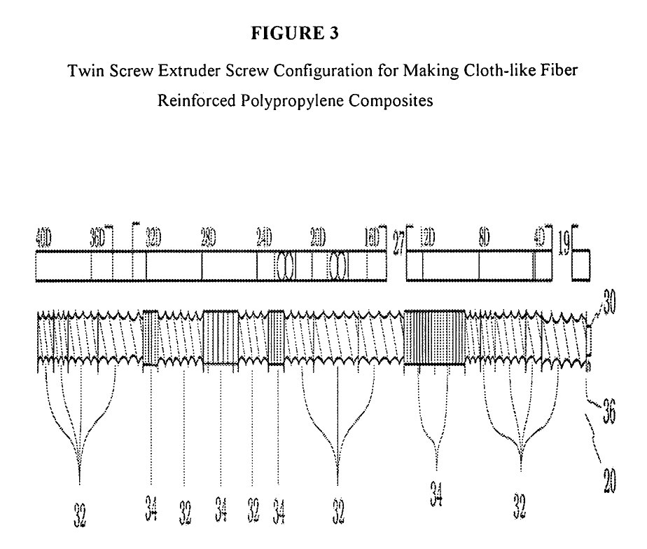

The position of each of the screw sections as expressed in the number of diameters (D) from the start 36 of the extruder screws 30 is also depicted in FIG. 3. The extruder screws in FIG. 3 have a length to diameter ratio of 40/1, and at a position 32D from the start 36 of screws 30, there is positioned a kneading element 34. The particular arrangement of kneading and conveying sections is not limited to that as depicted in FIG. 3, however one or more kneading blocks consisting of an arrangement of interconnected kneading elements 34 may be positioned in the twin screws 30 at a point downstream of where organic fiber and inorganic filler are introduced to the extruder barrel. The twin screws 30 may be of equal screw length or unequal screw length. Other types of mixing sections may also be included in the twin screws 30, including, but not limited to, Maddock mixers, and pin mixers.

Referring once again to FIG. 1, the uniformly mixed fiber reinforced polypropylene composite melt comprising polypropylene based polymer 10, inorganic filler 12, colorant fiber 13, and organic reinforcing fiber 14 is metered by the extruder screws to a strand die 28 for forming one or more continuous strands 40 of fiber reinforced polypropylene composite melt. The one or more continuous strands 40 are then passed into water bath 42 for cooling them below the melting point of the fiber reinforced polypropylene composite melt to form a solid fiber reinforced polypropylene composite strands 44. The water bath 42 is typically cooled and controlled to a constant temperature much below the melting point of the polypropylene based polymer. The solid fiber reinforced polypropylene composite strands 44 are then passed into a pelletizer or pelletizing unit 46 to cut them into fiber reinforced polypropylene composite resin 48 measuring from about ¼ inch to about 1 inch in length. The fiber reinforced polypropylene composite resin 48 may then be accumulated in boxes 50, barrels, or alternatively conveyed to silos for storage.

The present invention is further illustrated by means of the following examples, and the advantages thereto without limiting the scope thereof.

Test Methods

Fiber reinforced polypropylene compositions described herein were injection molded at 2300 psi pressure, 401° C. at all heating zones as well as the nozzle, with a mold temperature of 60° C.

Flexural modulus data was generated for injected molded samples produced from the fiber reinforced polypropylene compositions described herein using the ISO 178 standard procedure.

Instrumented impact test data was generated for injected mold samples produced from the fiber reinforced polypropylene compositions described herein using ASTM D3763. Ductility during instrumented impact testing (test conditions of 15 mph, −29° C., 25 lbs) is defined as no splintering of the sample.

### EXAMPLES

PP3505G is a propylene homopolymer commercially available from ExxonMobil Chemical Company of Baytown, Tex. The MFR (2.16 kg, 230° C.) of PP3505G was measured according to ASTM D1238 to be 400 g/10 min.

PP7805 is an 80 MFR propylene impact copolymer commercially available from ExxonMobil Chemical Company of Baytown, Tex.

PP8114 is a 22 MFR propylene impact copolymer containing ethylene-propylene rubber and a plastomer, and is commercially available from ExxonMobil Chemical Company of Baytown, Tex.

PP8224 is a 25 MFR propylene impact copolymer containing ethylene-propylene rubber and a plastomer, and is commercially available from ExxonMobil Chemical Company of Baytown, Tex.

PO1020 is 430 MFR maleic anhydride functionalized polypropylene homopolymer containing 0.5-1.0 weight percent maleic anhydride.

Cimpact CB7 is a surface modified talc and V3837 is a high aspect ratio talc, both available from Luzenac America Inc. of Englewood, Colo.

Granite Fleck is a masterbatch of dark polymer fiber in a linear low density carrier resin, and is commercially available from Uniform Color Company of Holland, Mich.

### Illustrative Examples 1-8

Varying amounts of PP3505G and 0.25″ long polyester reinforcing fibers obtained from Invista Corporation were mixed in a Haake single screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact under standard automotive conditions for interior parts (25 lbs, at 15 MPH, at −29° C.). The total energy absorbed and impact results are given in Table 1.

TABLE 1

| | | wt % | | |
|---|---|---|---|---|
| | wt % | Reinforcing | Total Energy | Instrumented Impact |
| Example # | PP3505G | Fiber | (ft-lbf) | Test Results |
| 1 | 65 | 35 | 8.6 ± 1.1 | ductile* |
| 2 | 70 | 30 | 9.3 ± 0.6 | ductile* |
| 3 | 75 | 25 | 6.2 ± 1.2 | ductile* |
| 4 | 80 | 20 | 5.1 ± 1.2 | ductile* |
| 5 | 85 | 15 | 3.0 ± 0.3 | ductile* |
| 6 | 90 | 10 | 2.1 ± 0.2 | ductile* |
| 7 | 95 | 5 | 0.4 ± 0.1 | brittle** |
| 8 | 100 | 0 | <0.1 | brittle*** |

*Examples 1-6: samples did not shatter or split as a result of impact, with no pieces coming off of the specimen.
**Example 7: pieces broke off of the sample as a result of the impact
***Example 8: samples completely shattered as a result of impact.

### Illustrative Examples 9-14

In Examples 9-11, 35 wt % PP7805, 20 wt % Cimpact CB7 talc, and 45 wt % 0.25″ long reinforcing polyester fibers obtained from Invista Corporation, were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact. The total energy absorbed and impact results are given in Table 2.

In Examples 12-14, PP8114 was extruded and injection molded under the same conditions as those for Examples 9-11. The total energy absorbed and impact results are given in Table 2.

TABLE 2

| | | | |
|---|---|---|---|
| | | Total | Instrumented |
| | | Energy | Impact Test |
| Example # | Impact Conditions/Applied Energy | (ft-lbf) | Results |

35 wt % PP7805 (70 MFR), 20 wt % talc, 45 wt % fiber

| | | | |
|---|---|---|---|
| 9 | −29° C., 15 MPH, 25 lbs/192 ft-lbf | 16.5 | ductile* |
| 10 | −29° C., 28 MPH, 25 lbs/653 ft-lbf | 14.2 | ductile* |
| 11 | −29° C., 21 MPH, 58 lbs/780 ft-lbf | 15.6 | ductile* |

100 wt % PP8114 (22 MFR)

| | | | |
|---|---|---|---|
| 12 | −29° C., 15 MPH, 25 lbs/192 ft-lbf | 32.2 | ductile* |
| 13 | −29° C., 28 MPH, 25 lbs/653 ft-lbf | 2.0 | brittle** |
| 14 | −29° C., 21 MPH, 58 lbs/780 ft-lbf | 1.7 | brittle** |

*Examples 9-12: samples did not shatter or split as a result of impact, with no pieces coming off of the specimen.
**Examples 13-14: samples shattered as a result of impact.

### Illustrative Examples 15-16

A Leistritz ZSE27 HP-60D 27 mm twin screw extruder with a length to diameter ratio of 40:1 was fitted with six pairs of kneading elements 12″ from the die exit. The die was ¼″ in diameter. Strands of continuous 27,300 denier PET reinforcing fibers were fed directly from spools into the hopper of the extruder, along with PP7805 and talc. The kneading elements in the extruder broke up the reinforcing fiber in situ. The extruder speed was 400 revolutions per minute, and the temperatures across the extruder were held at 190° C. Injection molding was done under conditions similar to those described for Examples 1-14. The mechanical and physical properties of the sample were measured and are compared in Table 3 with the mechanical and physical properties of PP8224.

The instrumented impact test showed that in both examples there was no evidence of splitting or shattering, with no pieces coming off the specimen. In the notched charpy test, the PET fiber-reinforced PP7805 specimen was only partially broken, and the PP8224 specimen broke completely.

TABLE 3

| | Example 15 | |
|---|---|---|
| Test | PET fiber-reinforced | Example 16 |
| (Method) | PP7805 with talc | PP8224 |
| Flexural Modulus, Chord | 525,190 psi | 159,645 psi |
| (ISO 178) | | |
| Instrumented Impact at −30° C. | 6.8 J | 27.5 J |
| Energy to maximum load | | |
| 100 lbs at 5 MPH | | |
| (ASTM D3763) | | |
| Notched Charpy Impact at −40° C. | 52.4 kJ/m² | 5.0 kJ/m² |
| (ISO 179/leA) | | |
| Heat Deflection Temperature | 116.5° C. | 97.6° C. |
| at 0.45 Mpa, edgewise | | |
| (ISO 75) | | |
| Coefficient of Linear Thermal | 2.2/12.8 | 10.0/18.6 |
| Expansion, −30° C. to 100° C., | (E-5/° C.) | (E-5/° C.) |
| Flow/Crossflow | | |
| (ASTM E831) | | |

### Illustrative Examples 17-18

In Examples 17-18, 30 wt % of either PP3505G or PP8224, 15 wt % 0.25″ long polyester reinforcing fibers obtained from Invista Corporation, and 45 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 4.

TABLE 4

| | | | Instrumented Impact at |
|---|---|---|---|
| | | | −30° C. |
| | | | Energy to maximum |
| | | Flexural Modulus, | load |
| | | Chord, psi | 25 lbs at 15 MPH |
| Example | Polypropylene, | (ISO 178) | (ASTM D3763), ft-lb |
| 17 | PP8224 | 433840 | 2 |
| 18 | PP3505 | 622195 | 2.9 |

The rubber toughened PP8114 matrix with PET reinforcing fibers and talc displayed lower impact values than the PP3505 homopolymer. This result is surprising, because the rubber toughened matrix alone is far tougher than the low molecular weight PP3505 homopolymer alone at all temperatures under any conditions of impact. In both examples above, the materials displayed no splintering.

### Illustrative Examples 19-24

In Examples 19-24, 25-75 wt % PP3505G, 15 wt % 0.25″ long polyester reinforcing fibers obtained from Invista Corporation, and 10-60 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 5.

TABLE 5

| | | Flexural Modulus, |
|---|---|---|
| Example | Talc Composition, | Chord, psi (ISO 178) |
| 19 | 10% | 273024 |
| 20 | 20% | 413471 |
| 21 | 30% | 583963 |
| 22 | 40% | 715005 |
| 23 | 50% | 1024394 |
| 24 | 60% | 1117249 |

It is important to note that in examples 19-24, the samples displayed no splintering in drop weight testing at an −29 C, 15 miles per hour at 25 pounds.

### Illustrative Examples 25-26

Two materials, one containing 10% ¼ inch polyester reinforcing fibers, 35% PP3505 polypropylene and 60% V3837 talc (example 25), the other containing 10% ¼ inch polyester reinforcing fibers, 25% PP3505 polypropylene homopolymer (example 26), 10% PO1020 modified polypropylene were molded in a Haake twin screw extruder at 175° C. They were injection molded into standard ASTM A370 ½ inch wide sheet type tensile specimens. The specimens were tested in tension, with a ratio of minimum to maximum load of 0.1, at flexural stresses of 70 and 80% of the maximum stress.

TABLE 6

| | Percentage of | | |
|---|---|---|---|
| | Maximum Stress to | Example 25, | Example 26, |
| Example | Yield Point | Cycles to failure | Cycles to failure |
| 25 | 70 | 327 | 9848 |
| 26 | 80 | 30 | 63 |

The addition of the modified polypropylene is shown to increase the fatigue life of these materials

### Illustrative Examples 27-29

A Leistritz 27 mm co-rotating twin screw extruder with a ratio of length to diameter of 40:1 was used in these experiments. The process configuration utilized was as depicted in FIG. 1. The screw configuration used is depicted in FIG. 3, and includes an arrangement of conveying and kneading elements. Talc, polypropylene and PET reinforcing fiber were all fed into the extruder feed hopper located approximately two diameters from the beginning of the extruder screws (19 in the FIG. 3). The PET reinforcing fiber was fed into the extruder hopper by continuously feeding from multiple spools a fiber tow of 3100 filaments with each filament having a denier of approximately 7.1. Each filament was 27 microns in diameter, with a specific gravity of 1.38.

The twin screw extruder ran at 603 rotations per minute. Using two gravimetric feeders, PP7805 polypropylene was fed into the extruder hopper at a rate of 20 pounds per hour, while CB 7 talc was fed into the extruder hopper at a rate of 15 pounds per hour. The PET reinforcing fiber was fed into the extruder at 12 pounds per hour, which was dictated by the screw speed and tow thickness. The extruder temperature profile for the ten zones 144° C. for zones 1-3, 133° C. for zone 4, 154° C. for zone 5, 135° C. for zone 6, 123° C. for zones 7-9, and 134° C. for zone 10. The strand die diameter at the extruder exit was ¼ inch.

The extrudate was quenched in an 8 foot long water trough and pelletized to ½ inch length to form PET/PP composite pellets. The extrudate displayed uniform diameter and could easily be pulled through the quenching bath with no breaks in the water bath or during instrumented impact testing. The composition of the PET/PP composite pellets produced was 42.5 wt % PP, 25.5 wt % PET, and 32 wt % talc.

The PET/PP composite resin produced was injection molded and displayed the following properties:

TABLE 7

| | Example 27 |
|---|---|
| Specific Gravity | 1.3 |
| Tensile Modulus, Chord @ 23° C. | 541865 psi |
| Tensile Modulus, Chord @ 85° C. | 257810 psi |
| Flexural Modulus, Chord @ 23° C. | 505035 psi |
| Flexural Modulus, Chord @ 85° C. | 228375 psi |
| HDT @ 0.45 MPA | 116.1° C. |
| HDT @ 1.80 MPA | 76.6° C. |
| Instrumented impact @ 23° C. | 11.8 J D** |
| Instrumented impact @ −30° C. | 12.9 J D** |

**Ductile failure with radial cracks

In example 28, the same materials, composition, and process set-up were utilized, except that extruder temperatures were increased to 175° C. for all extruder barrel zones. This material showed complete breaks in the instrumented impact test both at 23° C. and −30° C. Hence, at a barrel temperature profile of 175° C., the mechanical properties of the PET reinforcing fiber were negatively impacted during extrusion compounding such that the PET/PP composite resin had poor instrumented impact test properties.

In example 29, the fiber was fed into a hopper placed 14 diameters down the extruder (27 in the FIG. 3). In this case, the extrudate produced was irregular in diameter and broke an average once every minute as it was pulled through the quenching water bath. When the PET reinforcing fiber tow is continuously fed downstream of the extruder hopper, the dispersion of the PET in the PP matrix was negatively impacted such that a uniform extrudate could not be produced, resulting in the irregular diameter and extrudate breaking.

### Illustrative Example 30

An extruder with the same size and screw design as examples 27-29 was used. All zones of the extruder were initially heated to 180° C. PP 3505 dry mixed with Jetfine 700 C and PO 1020 was then fed at 50 pounds per hour using a gravimetric feeder into the extruder hopper located approximately two diameters from the beginning of the extruder screws. Polyester reinforcing fiber with a denier of 7.1 and a thickness of 3100 filaments was fed through the same hopper. The screw speed of the extruder was then set to 596 revolutions per minute, resulting in a feed rate of 12.1 pounds of fiber per hour. After a uniform extrudate was attained, all temperature zones were lowered to 120° C., and the extrudate was pelletized after steady state temperatures were reached. The final composition of the blend was 48% PP 3505, 29.1% Jetfine 700 C, 8.6% PO 1020 and 14.3% polyester reinforcing fiber.

The PP composite resin produced while all temperature zones of the extruder were set to 120° C. was injection molded and displayed the following properties:

TABLE 8

| | Example 30 |
|---|---|
| Flexural Modulus, Chord @ 23° C. | 467,932 psi |
| Instrumented impact @ 23° C. | 8.0 J D** |
| Instrumented impact @ −30° C. | 10.4 J D** |

**Ductile failure with radial cracks

### Illustrative Examples 31-34

4% Granite Fleck, which is a masterbatch of dark polymer fiber in a low density polyethylene carrier resin, was extrusion compounded with a twin screw extruder into both polypropylene based impact copolymer (PP 8114) (control sample) and also into a blend of PP homopolymer/PET fiber/talc (40% PP3505G polypropylene, 15% Invista PET reinforcing fiber (¼″ length), and 41% Luzenac Jetfine 3CA talc) (embodiment of present invention). Corresponding resin samples without the incorporation of the colorant fiber masterbatch (no Granite Fleck) were also produced to assess the impact of the colorant fiber on impact properties for the prior art PP impact copolymer and the PP-PET fiber reinforced composite of the present invention. The fiber reinforced polypropylene composite without the colorant fiber included 40% PP3505G polypropylene, 15% Invista PET reinforcing fiber (¼″ length), and 45% Luzenac Jetfine 3CA talc.

These four resin samples were molded in accordance with the geometry of ASTM D3763 and tested for instrumented impact resistance and failure mode upon impact failure. The instrumented impact test results are given in Table 9.

TABLE 9

| | | Instrumented | Failure mode | |
|---|---|---|---|---|
| | Material | impact (ft- | during instrumented | Flexural |
| Example | Composition | lbs) | impact | modulus (psi) |
| 31 | Impact copolymer | 32.2 | Ductile | No data |
| | (PP 8114) (prior art | | | |
| | control w/o colorant | | | |
| | fiber) | | | |
| 32 | Impact copolymer + colorant | 4.1 | Brittle | No data |
| | fiber (PP | | | |
| | 8114 + 4% Granite | | | |
| | Fleck) (prior art | | | |
| | control w/colorant | | | |
| | fiber) | | | |
| 33 | PP/PET fiber/talc | 11.9 | Ductile | 609,000 |
| | composite (40% PP | | | |
| | 3505G/15% PET | | | |
| | fiber/45% talc) | | | |
| | (present invention | | | |
| | w/o colorant fiber) | | | |
| 34 | PP/PET | 12.6 | Ductile | 606,000 |
| | fiber/talc/colorant | | | |
| | fiber composite (40% | | | |
| | PP 3505G/15% PET | | | |
| | fiber/41% talc/4% | | | |
| | Granite Fleck) | | | |
| | (present invention + colorant | | | |
| | fiber) | | | |

From Table 9, it is important to note that upon the incorporation of the colorant fiber into the impact polymer (Example 32) of the prior art, there is approximately a 88% decrease in instrumented impact resistance, and also the failure mode goes from ductile (no splintering) to brittle (splintering). In contrast, when colorant fiber is added to the PP/PET fiber/talc composition material (Example 34) of the present invention, there is no decrease in instrumented impact resistance, while the failure mode remains ductile in nature, with negligible reduction in flexural modulus. The PP/PET fiber/talc/colorant fiber composite material after molding also has a cloth-like look to it from the incorporation of the dark colorant fiber uniformly dispersed through the molded object. Surprisingly, the PP/PET fiber/talc/colorant fiber composite material (Example 34) retains its outstanding impact resistance unlike the prior art rubber modified PP impact copolymer/colorant fiber sample (Example 32).

All patents, test procedures, and other documents cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which the invention pertains.

When numerical lower limits and numerical upper limits are listed herein, ranges from any lower limit to any upper limit are contemplated.

What is claimed is:

1. A polypropylene resin composition comprising:
(a) at least 30 wt %, based on the total weight of the composition, polypropylene based polymer;
(b) from 10 to 60 wt %, based on the total weight of the composition, organic reinforcing fiber;
(c) from 0 to 40 wt %, based on the total weight of the composition, inorganic filler; and
(d) from 0.1 to 2.5 wt %, based on the total weight of the composition, colorant fiber;
wherein an article molded from said composition has a flexural modulus of at least 300,000 psi, exhibits ductility during instrumented impact testing, and exhibits a cloth-like appearance.

2. The polypropylene resin composition of claim 1 wherein said polypropylene based polymer is selected from the group consisting of polypropylene homopolymers, propylene-ethylene random copolymers, propylene-α-olefin random copolymers, propylene impact copolymers, and combinations thereof.

3. The polypropylene resin composition of claim 2 wherein said polypropylene based polymer is polypropylene homopolymer.

4. The polypropylene resin composition of claim 1 wherein said polypropylene based polymer further comprises from about 0.01 wt % to less than about 0.1 wt % of a modifier selected from the group consisting of acrylic acid, methacrylic acid, maleic acid, itaconic acid, fumaric acid or esters thereof, maleic anhydride, itaconic anhydride, and combinations thereof.

5. The polypropylene resin composition of claim 1 wherein said organic reinforcing fiber and said colorant fiber are dispersed randomly within said polypropylene based polymer.

6. The polypropylene resin composition of claim 5 wherein said organic reinforcing fiber is selected from the group consisting of polyalkylene terephthalates, polyalkylene naphthalates, polyamides, polyolefins, polyacrylonitrile, and combinations thereof.

7. The polypropylene resin composition of claim 6 wherein said organic reinforcing fiber is polyethylene terephthalate.

8. The polypropylene resin composition of claim 1 wherein said inorganic filler is selected from group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

9. The polypropylene resin composition of claim 8 wherein said inorganic filler is talc or wollastonite.

10. The polypropylene resin composition of claim 5 wherein said colorant fiber includes an inorganic pigment, an organic dye, or a combination thereof.

11. The polypropylene resin composition of claim 10 wherein said colorant fiber is selected from the group consisting of cellulosic fiber, acrylic fiber, nylon type fiber, polyester type fiber, and combinations thereof.

12. The polypropylene resin composition of claim 11 wherein said colorant fiber is from about 1/32 inch to about ¼ inch in length.

13. The polypropylene resin composition of claim 12 wherein said polypropylene based polymer further comprises an inorganic pigment, an organic dye, or a combination thereof.

14. The polypropylene resin composition of claim 13 wherein said article molded from said composition has a flexural modulus of at least 450,000 psi.

15. A polypropylene resin composition comprising:
(a) at least 25 wt %, based on the total weight of the composition, polypropylene based polymer with a melt flow rate of from about 20 to about 1500 g/10 minutes;
(b) from 5 to 40 wt %, based on the total weight of the composition, organic reinforcing fiber;
(c) from 10 to 60 wt %, based on the total weight of the composition, inorganic filler; and
(d) from 0.1 to 2.5 wt %, based on the total weight of the composition, colorant fiber;
wherein an article molded from said composition has a flexural modulus of at least about 300,000 psi, exhibits ductility during instrumented impact testing, and exhibits a cloth-like appearance.

16. The polypropylene resin composition of claim 15 wherein said polypropylene based polymer is selected from the group consisting of polypropylene homopolymers, propylene-ethylene random copolymers, propylene-α-olefin random copolymers, propylene impact copolymers, and combinations thereof.

17. The polypropylene resin composition of claim 16 wherein said polypropylene based polymer is polypropylene homopolymer with a melt flow rate of from about 150 to about 1500 g/10 minutes.

18. The polypropylene resin composition of claim 15 wherein said polypropylene based polymer further comprises from about 0.1 wt % to less than about 10 wt % of a polypropylene based polymer modified with a grafting agent, wherein said grafting agent is selected from the group consisting of acrylic acid, methacrylic acid, maleic acid, itaconic acid, fumaric acid or esters thereof, maleic anhydride, itaconic anhydride, and combinations thereof.

19. The polypropylene resin composition of claim 15 wherein said organic reinforcing fiber and said colorant fiber are dispersed randomly within said polypropylene based polymer.

20. The polypropylene resin composition of claim 19 wherein said organic reinforcing fiber is selected from the group consisting of polyalkylene terephthalates, polyalkylene naphthalates, polyamides, polyolefins, polyacrylonitrile, and combinations thereof.

21. The polypropylene resin composition of claim 20 wherein said organic reinforcing fiber is polyethylene terephthalate at a loading from about 7.5% to about 20 wt %.

22. The polypropylene resin composition of claim 15 wherein said inorganic filler is selected from group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

23. The polypropylene resin composition of claim 22 wherein said inorganic filler is talc or wollastonite at a loading from about 20% to about 60 wt %.

24. The polypropylene resin composition of claim 23 wherein the size of said talc is from about 1 to about 100 microns.

25. The polypropylene resin composition of claim 19 wherein said colorant fiber includes an inorganic pigment, an organic dye, or a combination thereof.

26. The polypropylene resin composition of claim 25 wherein said colorant fiber is selected from the group consisting of cellulosic fiber, acrylic fiber, nylon type fiber, polyester type fiber, and combinations thereof.

27. The polypropylene resin composition of claim 26 wherein said colorant fiber is from about 1/32 inch to about ⅛ inch in length.

28. The polypropylene resin composition of claim 27 wherein said polypropylene based polymer further comprises an inorganic pigment, an organic dye, or a combination thereof.

29. The polypropylene resin composition of claim 28 wherein said article molded from said composition has a flexural modulus of at least about 600,000 psi.

30. The polypropylene resin composition of claim 29 wherein said article molded from said composition has a flexural modulus of at least about 1,000,000 psi.

31. A polypropylene resin composition comprising:
(a) at least 30 wt %, based on the total weight of the composition, polypropylene based polymer;
(b) from 5 to 40 wt %, based on the total weight of the composition, organic reinforcing fiber;
(c) from 10 to 60 wt %, based on the total weight of the composition, inorganic filler;
(d) from 0.01 to 0.1 wt %, based on the total weight of the composition, lubricant; and
(e) from 0.1 to 1.0 wt %, based on the total weight of the composition, colorant fiber;
wherein an article molded from said composition has a flexural modulus of at least about 300,000 psi, exhibits ductility during instrumented impact testing, and exhibits a cloth-like appearance.

32. The polypropylene resin composition of claim 31 wherein said lubricant is selected from the group consisting of silicon oil, silicon gum, fatty amide, paraffin oil, paraffin wax, and ester oil.

33. The polypropylene resin composition of claim 31 wherein said polypropylene based polymer is polypropylene homopolymer.

34. The polypropylene resin composition of claim 31 wherein said organic reinforcing fiber and said colorant fiber are dispersed randomly within said polypropylene based polymer.

35. The polypropylene resin composition of claim 34 wherein said organic reinforcing fiber is polyethylene terephthalate.

36. The polypropylene resin composition of claim 35 wherein said inorganic filler is talc or wollastonite.

37. The polypropylene resin composition of claim 34 wherein said colorant fiber includes an inorganic pigment, an organic dye, or a combination thereof.

38. The polypropylene resin composition of claim 37 wherein said colorant fiber is selected from the group consisting of cellulosic fiber, acrylic fiber, or nylon type fiber.

39. The polypropylene resin composition of claim 38 wherein said colorant fiber is from about 1/32 inch to about ⅛ inch in length.

40. The polypropylene resin composition of claim 39 wherein said polypropylene based polymer further comprises an inorganic pigment, an organic dye, or a combination thereof.

41. A polypropylene resin composition comprising:
(a) at least 25 wt %, based on the total weight of the composition, polypropylene based polymer, wherein said polypropylene based polymer has a melt flow rate of at least 80 g/10 minutes;
(b) from 5 to 15 wt %, based on the total weight of the composition, organic reinforcing fiber;
(c) from 50 to 60 wt %, based on the total weight of the composition, talc or wollastonite; and
(d) from 0.1 to 1.0 wt %, based on the total weight of the composition, colorant fiber;
wherein an article molded from said composition has a flexural modulus of at least about 750,000 psi, exhibits ductility during instrumented impact testing, and exhibits a cloth-like appearance.

42. The polypropylene resin composition of claim 41 wherein said polypropylene based polymer is polypropylene homopolymer with a melt flow rate of at least about 400 g/10 minutes.

43. The polypropylene resin composition of claim 41 wherein said polypropylene based polymer further comprises from about 0.1 wt % to less than about 10 wt % of a polypropylene based polymer modified with a grafting agent, wherein said grafting agent is selected from the group consisting of acrylic acid, methacrylic acid, maleic acid, itaconic acid, fumaric acid or esters thereof, maleic anhydride, itaconic anhydride, and combinations thereof.

44. The polypropylene resin composition of claim 41 wherein said organic reinforcing fiber and said colorant fiber are dispersed randomly within said polypropylene based polymer.

45. The polypropylene resin composition of claim 44 wherein said organic reinforcing fiber is polyethylene terephthalate.

46. The polypropylene resin composition of claim 44 wherein said colorant fiber includes an inorganic pigment, an organic dye, or a combination thereof.

47. The polypropylene resin composition of claim 46 wherein said colorant fiber is selected from the group consisting of cellulosic fiber, acrylic fiber, or nylon type fiber.

48. The polypropylene resin composition of claim 47 wherein said polypropylene based polymer further comprises an inorganic pigment, an organic dye, or a combination thereof.

49. The polypropylene resin composition of claim 48 wherein said article molded from said composition has a flexural modulus of at least about 1,000,000 psi.

50. A polypropylene resin composition comprising:
(a) at least 40 wt %, based on the total weight of the composition, polypropylene based polymer, wherein said polypropylene based polymer has a melt flow rate of at least 100 g/10 minutes;
(b) from 10 to 30 wt %, based on the total weight of the composition, organic reinforcing fiber;
(c) from 10 to 30 wt %, based on the total weight of the composition, talc or wollastonite; and
(d) from 0.1 to 1.0 wt %, based on the total weight of the composition, colorant fiber;
wherein an article molded from said composition has a flexural modulus of at least about 325,000 psi, exhibits ductility during instrumented impact testing, and exhibits a cloth-like appearance.

51. The polypropylene resin composition of claim 50 wherein said polypropylene based polymer is polypropylene homopolymer with a melt flow rate of at least about 400 g/10 minutes.

52. The polypropylene resin composition of claim 50 wherein said polypropylene based polymer further comprises from about 0.1 wt % to less than about 10 wt % of a polypropylene based polymer modified with a grafting agent, wherein said grafting agent is selected from the group consisting of acrylic acid, methacrylic acid, maleic acid, itaconic acid, fumaric acid or esters thereof, maleic anhydride, itaconic anhydride, and combinations thereof.

53. The polypropylene resin composition of claim 50 wherein said organic reinforcing fiber and colorant fiber are dispersed randomly within said polypropylene based polymer.

54. The polypropylene resin composition of claim 53 wherein said organic reinforcing fiber is polyethylene terephthalate.

55. The polypropylene resin composition of claim 54 wherein said colorant fiber includes an inorganic pigment, an organic dye, or a combination thereof.

56. The polypropylene resin composition of claim 55 wherein said colorant fiber is selected from the group consisting of cellulosic fiber, acrylic fiber, or nylon type fiber.

57. The polypropylene resin composition of claim 56 wherein said polypropylene based polymer further comprises an inorganic pigment, an organic dye, or a combination thereof.

58. The polypropylene resin composition of claim 57 wherein said article molded from said composition has a flexural modulus of at least about 375,000 psi.

59. A method of making an article from a polypropylene resin composition comprising:
(a) at least 30 wt %, based on the total weight of the composition, polypropylene based polymer;
(b) from 10 to 60 wt %, based on the total weight of the composition, organic reinforcing fiber;
(c) from 0 to 40 wt %, based on the total weight of the composition, inorganic filler; and
(d) from 0.1 to 2.5 wt %, based on the total weight of the composition, colorant fiber;
wherein said article molded from said composition has a flexural modulus of at least 300,000 psi, exhibits ductility during instrumented impact testing, and exhibits a cloth-like appearance; wherein said method comprises the steps of:
(a) twin screw extrusion compounding said composition to form a resin; and
(b) injection molding said resin to form an article.

60. The method of claim 59 wherein said injection molding step further comprises the step of providing a mold with a textured surface, wherein said article further exhibits a cloth-like feel.

61. The method of claim 59, wherein said organic reinforcing fiber is cut prior to the twin screw extrusion compounding step.

62. The method of claim 59, wherein during said twin screw extrusion compounding step, the organic fiber is a continuous fiber and is fed directly from one or more spools into an extruder hopper.

63. An automotive part made by the method of claim 59.

64. The automotive part of claim 63, wherein said automotive part is an interior trim cover panel selected from the group consisting of a steering wheel cover, a head liner panel, a dashboard panel, an interior door trim panel, a pillar trim cover panel, and an under-dashboard panel.

65. A method of making a fiber reinforced polypropylene resin composition comprising:
(a) at least 25 wt %, based on the total weight of the composition, polypropylene based polymer with a melt flow rate of from about 20 to about 1500 g/10 minutes;
(b) from 5 to 40 wt %, based on the total weight of the composition, organic reinforcing fiber;
(c) from 10 to 60 wt %, based on the total weight of the composition, inorganic filler; and
(d) from 0.1 to 2.5 wt %, based on the total weight of the composition, colorant fiber;
wherein an article molded from said composition has a flexural modulus of at least about 300,000 psi, exhibits ductility during instrumented impact testing, and exhibits a cloth-like appearance; wherein said method comprises the steps of:
(a) feeding into a twin screw extruder hopper said polypropylene based polymer;
(b) continuously feeding by unwinding from one or more spools into said twin screw extruder hopper said organic reinforcing fiber;
(c) feeding into said twin screw extruder said inorganic filler and said colorant fiber;
(d) extruding said polypropylene based resin, said organic reinforcing fiber, said inorganic filler, and said colorant fiber through said twin screw extruder to form a fiber reinforced polypropylene composite melt;
(e) cooling said fiber reinforced polypropylene composite melt to form a solid polypropylene composition; and
(f) pelletizing said solid polypropylene composition to form a fiber reinforced polypropylene resin composition.

66. The method of claim 65 wherein said polypropylene based resin is selected from the group consisting of polypropylene homopolymers, propylene-ethylene random copolymers, propylene-α-olefin random copolymers, propylene impact copolymers, and combinations thereof.

67. The method of claim 66 wherein said polypropylene based resin is polypropylene homopolymer with a melt flow rate of from about 150 to about 1500 g/10 minutes.

68. The method of claim 65 wherein said organic reinforcing fiber is selected from the group consisting of polyalkylene terephthalates, polyalkylene naphthalates, polyamides, polyolefins, polyacrylonitrile, and combinations thereof.

69. The method of claim 68 wherein said organic reinforcing fiber is polyethylene terephthalate.

70. The method of claim 65 wherein said inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

71. The method of claim 70 wherein said inorganic filler is talc or wollastonite.

72. The method of claim 65 wherein said colorant fiber includes an inorganic pigment, an organic dye, or a combination thereof.

73. The method of claim 72 wherein said colorant fiber is selected from the group consisting of cellulosic fiber, acrylic fiber, nylon type fiber, polyester type fiber, and combinations thereof.

74. The method of claim 73 wherein said polypropylene based polymer further comprises an inorganic pigment, an organic dye, or a combination thereof.

75. The method of claim 65 wherein said colorant fiber is in the form of a masterbatch comprising a carrier resin selected from the group consisting of polypropylene homopolymer, ethylene-propylene copolymer, ethylene-propylene-butene-1 terpolymer, propylene-butene-1 copolymer, low density polyethylene, high density polyethylene, and linear low density polyethylene.

76. The method of claim 65 wherein said twin screw extruder comprises barrel temperature control zone set points of less than or equal to 185° C.

77. The method of claim 76 wherein said twin screw extruder comprises barrel temperature control zone set points of less than or equal to 165° C.

78. An automotive part made by the method of claim 65.

79. The automotive part of claim 78, wherein said automotive part is an interior trim cover panel selected from the group consisting of a steering wheel cover, a head liner panel, a dashboard panel, an interior door trim panel, a pillar trim cover panel, and an under-dashboard panel.
